(19) United States
(12) Patent Application Publication
(10) Pub. No.: US 2013/0073319 A1
(43) Pub. Date: Mar. 21, 2013

(54) APPARATUS, METHOD AND COMPUTER PROGRAM PRODUCT FOR DETERMINING COMPOSITE HAZARD INDEX

(71) Applicants: Wei DU, Springfield, VA (US); Thomas C. JEFFERY, Milton, WI (US); Howard BOTTS, Madison, WI (US)

(72) Inventors: Wei DU, Springfield, VA (US); Thomas C. JEFFERY, Milton, WI (US); Howard BOTTS, Madison, WI (US)

(73) Assignee: Corelogic Solutions, LLC, Santa Ana, CA (US)

(21) Appl. No.: 13/238,059

(22) Filed: Sep. 21, 2011

(51) Int. Cl. G06Q 40/08

(52) U.S. Cl. 705/4

(57) ABSTRACT

An apparatus, method and computer program storage device determine a composite hazard index. An interface receives a first risk score for a first hazard and a second risk score for a second hazard. The first risk score is in a first range of scores and the second risk score is in a second range of scores. A processing circuit emphasizes at least some scores in at least one of the first range of scores and the second range of scores. The processing circuit also normalizes the first risk score with respect to the first range of scores and second range of scores, and normalizes the second risk score with respect to the first range of scores and second range of scores. The processing circuit also combines a normalized first risk score with a normalized second risk score to form at least a component of a composite risk index. The first risk score and second risk score being specific to a common property.

### CROSS REFERENCE TO RELATED PATENT DOCUMENT

The present application contains subject matter related to U.S. patent application Ser. No. 12/027,096, filed Feb. 6, 2008, the entire contents of which is being incorporated herein by reference.

### BACKGROUND

1. Technical Field

The present description relates to systems, methods and computer program product regarding techniques for applying scores to hazards, and in particular, to developing a composite risk index value for one or more parcels with respect to multiple hazard risks.

2. Description of the Related Art

The need to accurately identify natural hazard risk for properties has grown steadily during the last half of the twentieth century, with the observance of ever increasing property loss due to earthquakes, hurricanes, wildfires, floods and various severe weather events, all of which being hazard risks. The first decade of the twenty-first century has witnessed ever greater concern over the location of properties in relation to natural hazard regions/paths of frequency. Historically, risk to properties has been, and continues to be, evaluated separately for each risk category. For example, a single residential property along the coast of California may be evaluated for earthquake risk, while ignoring the risk of the property for a wildfire event. However, if the probability of a wildfire is investigated at that property, the wildfire risk will be determined singularly for the property, without consideration of other hazards. As a result, and as recognized by the present inventors, the overall or composite risk for a property, which may be significant due to the effect of multiple hazards in some areas, is either miscalculated as a simple sum of the individual risk components, or is overlooked completely.

In 2011, as an example, certain properties in Japan not only experienced earthquake damage from a severe 7.0 earthquake, but properties near the shore line, were also devastated due to a tsunami. From an insurance carrier's perspective, flood damage may be calculated independently of earthquake damage.

As another example, in the Washington, D.C. area in 2011, within one week's time, a rare, but powerful earthquake centered in Virginia shook properties all along the east coast. Just one week later, hurricane Irene exposed many of the same properties to damage, not only from hurricane-force wind, but also from flood damage from the associated immense rainfall in certain areas. Once again, from the property owner's perspective, separate insurance is obtainable for various kinds of hazard risks, including fire damage, wind damage, flood damage, and earthquake damage for example. From the insurer's perspective, there may be a lost opportunity to provide generic hazard insurance for a wide range of hazards. From the insured's perspective there may be a lack of confidence that “the right kind of insurance” was obtained for their property since it may have been unbeknownst to them that their property could possibly be at risk due to a rare event, such as an earthquake.

Each insurance policy is generally established by assessing each of the natural hazards independent of one another, many of which being based on generalities of properties within particular regions, without full recognition of the relatedness between hazard risk for parcels, nor the various types of disparate hazards that may be present in a particular area.

Insurance providers and underwriters typically use hazard risk metrics associated with the type of hazard for which they are providing insurance. For example, one particular kind of hazard may be categorized in terms of text, non-numeric units (e.g., no risk, low risk, high risk). However, another type of hazard may use a numeric scale from 1 to 100 for example. As recognized by the present inventors, in many circumstances the property owner would prefer to have one policy that covered all types of hazards since it would give the property owner peace of mind that they are covered, no matter what happens. However, due to disparate risk appraisal systems, such coverage is not readily available without significant customized analysis of particular properties due to a variety of potential hazards.

### SUMMARY OF THE INVENTION

As recognized by the present inventors, having disparate metrics for assessing the risk from different hazards for a particular property makes it difficult to assess the overall risk of a particular property to all natural hazards. Furthermore, the separate incompatible metrics used for assessing the different risks, lend themselves to the presumption that the relatedness between hazards are mutually exclusive and thus each hazard is analyzed independently. This approach of assessing the mutual hazards independently, avoids the benefit of identifying a true composite risk score that accurately compiles the totality of individual risks into a single value. Having the individual risk compiled into a single value becomes increasingly important as property owners, businesses and government units work to take steps to identify, prepare for and mitigate the risk from natural hazards.

One of the benefits of developing a composite risk score is, regardless of the root causes of the property losses, the composite risk score reflects the likelihood of damage to the property. Moreover, by developing a composite risk index for overall hazard risk impact, various entities can easily assess risk with regard to particular parcels, because they have an accurate single point assessment that would allow for the comparison of risk between different parcels. For example, one benefit with a composite risk index is that an entity can compare the risk between a property in California (e.g., earthquake and brush fire) with a property in Florida (wind damage and storm surge). Having the composite index should be directly correlated to the overall economic losses, regardless of the source of the hazard. By having a single risk score, it could be used by different facets of the insurance industry. For example, the actuarial department could use the composite index in developed rating territories while an underwriting department might use it for risk screening and for underwriting. Utilities, telecommunication companies, and the oil and gas industries, may benefit from the single score for evaluating enterprise risk management. Likewise, housing industry banks could use the composite index for evaluating the risk of loss for homes with high loan-to-value amounts.

As opposed to the present process of individually evaluating hazards in isolation from one another, a composite risk score enables an insurer to have a tool to assist them in more accurately comparing the risk for each property across an entire portfolio of properties. This would help solve the present problem in which it is impossible to effectively compare properties that are influenced by different types of risk because there is no method of unifying the risk to a common metric.

Consistent with the above description, selected embodiments of the present disclosure establish a mathematical relationship between the composite risk index and normalized risk scores from various hazards (perils) on a parcel-by-parcel basis, under different design scenarios. Accordingly, a relationship is established between disparate metrics and scoring systems for different risk hazards, into a common, composite score. As input, various hazard risk scores, whether they are numeric (unconverted), or non-numeric (first converted to a numeric score), are amplified (or emphasized, such as being squared) to develop a single hazard score. Then the different amplified scores are normalized, before calculating a composite index value. The system may be employed on a single computer, or in a network of computers, including cloud-based resources. As an example, the service may be hosted on a remote computer, that is accessible by way of an interne browser for example. The composite score may then be associated with a particular loss value for a particular parcel, so that estimates of insurability, and insurance premiums, as well as risk loss, may be assessed using the single composite index.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a computer-based system and network that may be employed for information exchange, processing capability and analysis, according to one embodiment;

FIG. 2 is a computer system that may be suitable for implementing various embodiments of a system and method for developing a composite risk index according to the embodiment;

FIG. 3 is a front-view of an exemplary mobile tablet computer that may be employed to compliment or as a substitute for the computer system of FIG. 2;

FIG. 4 is a back-view of the mobile tablet computer of FIG. 3;

FIG. 5 is a block diagram of selected components of the mobile tablet computer of FIG. 3;

FIG. 6 is a table showing a conversion between a non-nominal scoring system for a particular peril, to a numeric conversion that corresponds with the non-numeric metric;

FIG. 7 is a table showing an amplification of particular values for particular parcels on a peril-by-peril basis;

FIG. 8 is a table showing exemplary normalized values for the amplified values discussed above with regard to FIG. 7;

FIG. 9 includes the normalized score for each value, as well as an associated composite index that is calculated for each parcel, in light of the multiple perils on which the parcel is assessed;

FIG. 10 is a table showing a truncated table, that includes the total values and composite indexes for the different parcels which may be then used for assessment of parcels;

FIG. 11 is a flow chart of a process flow that converts normalizes and calculates a composite index value from a disparate set of different risk scores for different hazards; and

FIG. 12 is a more detailed flow chart, showing the association of particular parcels, with the assessment of those parcels, and the resultant composite index value obtained for the particular parcels, after an assessment of the different risks associated with that parcel have been analyzed.

### DETAILED DESCRIPTION

The following describes various aspects of a system, method and computer program product that determines a composite hazard index for particular parcels. First, computer related resources used in performing the composite risk index analysis is described, followed by the methodology for performing the composite index analysis.

Computer Resources

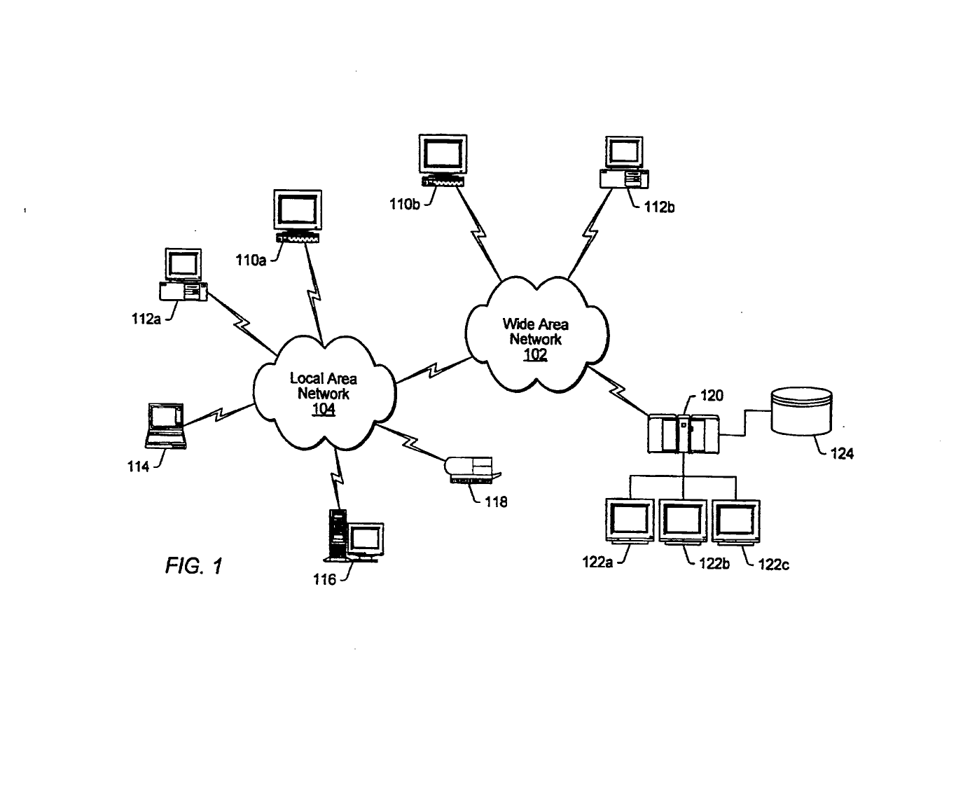

FIG. 1 illustrates an embodiment of a WAN 102 and a LAN 104. WAN 102 may be a network that spans a relatively large geographical area, and may optionally include cloud computing resources that host applications, and/or provide computing and storage resources as needed to supplement the processes and resources discussed herein. The Internet is an example of a WAN 102. WAN 102 typically includes a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

One or more LANs 104 maybe coupled to WAN 102. LAN 104 may be a network that spans a relatively small area. Typically, LAN 104 may be confined to a single building or group of buildings. Each node (i.e., individual computer system or device) on LAN 104 may have its own CPU with which it may execute programs. Each node may also be able to access data and devices anywhere on LAN 104. LAN 104, thus, may allow many users to share devices (e.g., printers) and data stored on file servers. LAN 104 may be characterized by a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, and/or radio waves).

Each LAN 104 may include a plurality of interconnected computer systems and optionally one or more other devices. For example, LAN 104 may include one or more workstations 110a, one or more personal computers 112a, one or more laptop or notebook computer systems 114, one or more server computer systems 116, and one or more network printers 118. As illustrated in FIG. 1, an example LAN 104 may include one of each computer systems 110a, 112a, 114, and 116, and one printer 118. LAN 104 may be coupled to other computer systems and/or other devices and/or other LANs through WAN 102.

One or more mainframe computer systems 120 may be coupled to WAN 102. As shown, mainframe 120 may be coupled to a storage device or file server 124 and mainframe terminals 122a, 1226, and 122c. Mainframe terminals 122a, 122b, and 122c may access data stored in the storage device or file server 124 coupled to or included in mainframe computer system 120.

WAN 102 may also include computer systems connected to WAN 102 individually and not through LAN 104. For example, workstation 11 OA and personal computer 112b may be connected to WAN 102. For example, WAN 102 may include computer systems that may be geographically remote and connected to each other through the Internet.

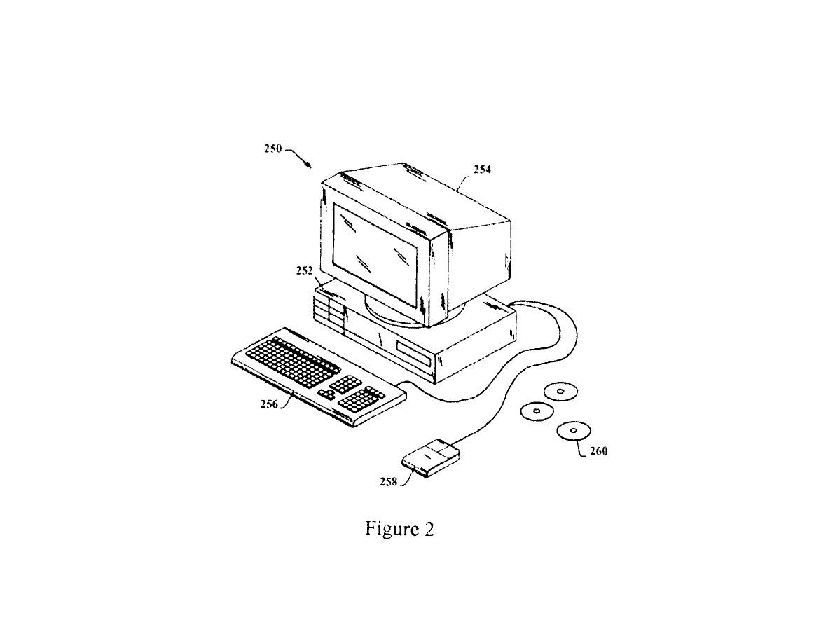

FIG. 2 illustrates an embodiment of computer system 250 that may be suitable for implementing various embodiments of a system and method for flood risk assessment. Each computer system 250 typically includes components such as CPU 252 with an associated memory medium such as CD-ROMs 260. The memory medium may store program instructions for computer programs. The program instructions may be executable by CPU 252. Computer system 250 may further include a display device such as monitor 254, an alphanumeric input device such as keyboard 256, and a directional input device such as mouse 258. Computer system 250 may be operable to execute the computer programs to implement computer-implemented systems and methods for flood risk assessment.

Computer system 250 may include a memory medium on which computer programs according to various embodiments may be stored. The term “memory medium” is intended to include an installation medium, e.g., floppy disks or CDROMs 260, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. Computer system 250 may take various forms such as a personal computer system, tablet computer, smartphone (e.g, IPHONE, with associated APPS), mainframe computer system, workstation, network appliance, Internet appliance, personal digital assistant (“PDA”), television system or other device. In general, the term “computer system” may refer to any device having a processor that executes instructions from a memory medium (non-transitory computer readable storage device).

The memory medium may store a software program, such as an APP, or programs operable to implement a method for flood risk assessment. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (“MFC”), browser-based applications (e.g., Java applets), APPs like those available from APPLE COMPUTER's APP STORE, traditional programs, or other technologies or methodologies, as desired. A CPU such as host CPU 252 executing code and data from the memory medium may include a means for creating and executing the software program or programs according to the embodiments described herein.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

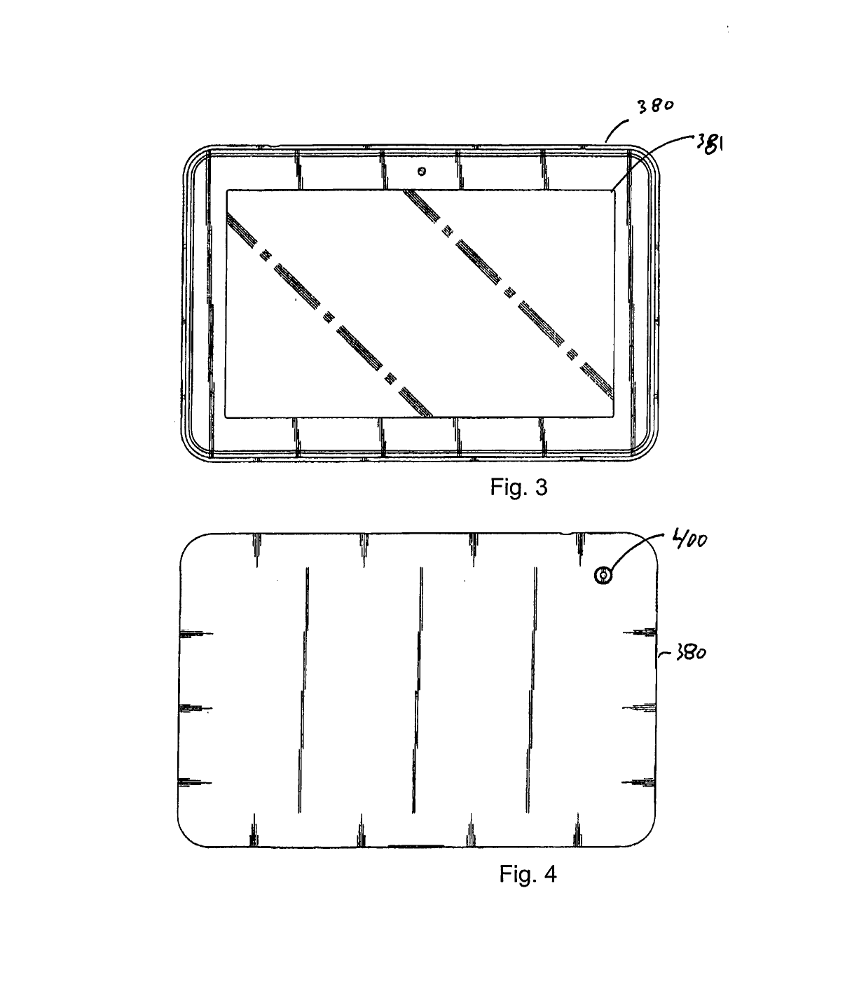

FIG. 3 is a front view of a tablet computer 380 having a touch screen 381. The tablet computer 380 is a mobile device that allows individuals to provide input through the touch panel 381 and also receive a displayed result. As will be discussed in future embodiments, the mobile tablet computer 380 is one example of a mobile device, others being smart phones, laptop computers, etc., that allow an operator to execute either locally or remotely (perhaps through a cloud computing service) applications that assist the user in recording data regarding particular property. For example the GPS (Global Positioning System) feature in the tablet computer 380 enables the user to walk to particular locations on a parcel, perhaps near each corner of a building, and record the latitude, longitude and elevation (either directly from the GPS module in the tablet computer or through an associated APP, such as CURRENT ELEVATION) at that location, which may then be associated with the footprint of the structure to which later flood risk scores may be associated.

FIG. 4 is a backside view of the tablet computer 380. The backside includes a camera 400. Alternatively, the camera may be included on the front of the tablet computer 380. The camera may either be a digital still camera, and/or a video camera.

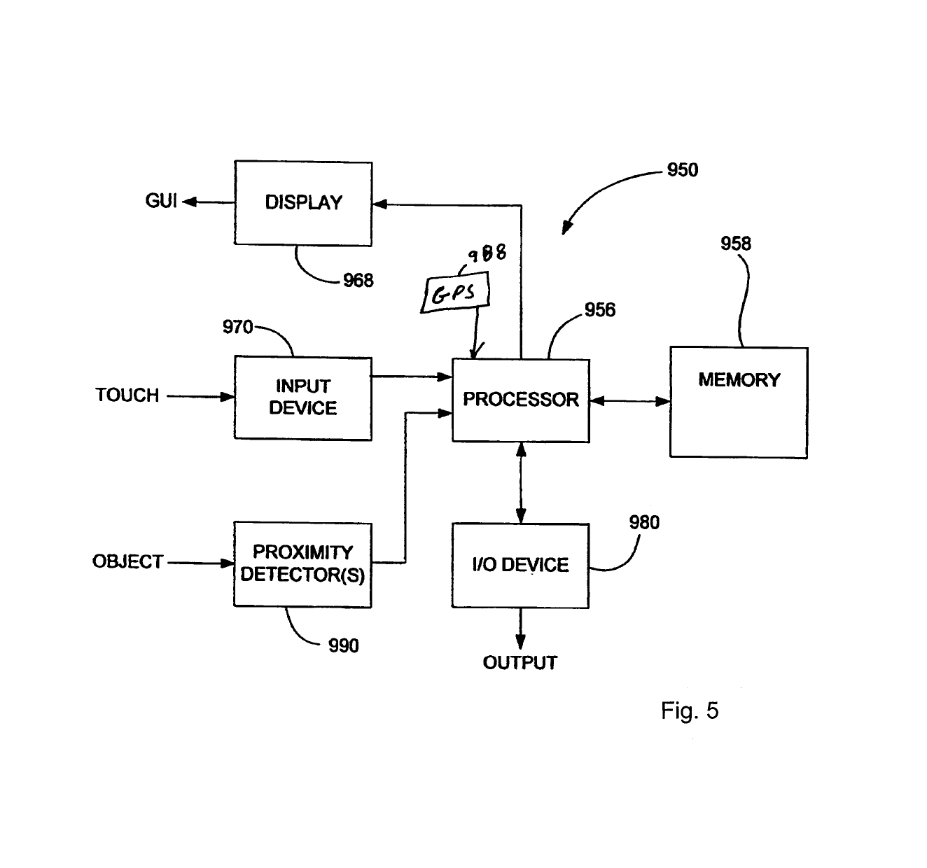

FIG. 5 is a block diagram of an exemplary computer system 950, in accordance with one embodiment of the present invention. The computer system 950 may correspond to a personal computer, such as a desktop, laptop, tablet or handheld computer. The computer system may also correspond to other types of computing devices such as a cell phones, PDAs, media players, consumer electronic devices, and/or the like.

The exemplary computer system 950 shown in FIG. 5 includes a processor 956 configured to execute instructions and to carry out operations associated with the computer system 950. For example, using instructions retrieved for example from memory, the processor 956 may control the reception and manipulation of input and output data between components of the computing system 950. The processor 956 can be implemented on a single-chip, multiple chips or multiple electrical components. For example, various architectures can be used for the processor 956, including dedicated or embedded processor, single purpose processor, controller, ASIC, and so forth.

In most cases, the processor 956 together with an operating system operates to execute computer code and produce and use data. By way of example, the operating system may correspond to Mac OS, OS/2, DOS, Unix, Linux, Palm OS, and the like. The operating system can also be a special purpose operating system, such as may be used for limited purpose appliance-type computing devices. The operating system, other computer code and data may reside within a memory block 958 that is operatively coupled to the processor 656. Memory block 958 generally provides a place to store computer code and data that are used by the computer system 950. By way of example, the memory block 958 may include Read-Only Memory (ROM), Random-Access Memory (RAM), hard disk drive and/or the like. The information could also reside on a removable storage medium and loaded or installed onto the computer system 950 when needed. Removable storage media include, for example, CD-ROM, PC-CARD, memory card, floppy disk, magnetic tape, and a network component.

The computer system 950 also includes a display device 968 that is operatively coupled to the processor 956. The display device 968 may be a liquid crystal display (LCD) (e.g., active matrix, passive matrix and the like) with a touchscreen capability. Alternatively, the display device 968 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks or OLEDs.

The display device 968 is generally configured to display a graphical user interface (GUI) that provides an easy to use interface between a user of the computer system and the operating system or application running thereon. Generally speaking, the GUI represents, programs, files and operational options with graphical images. The graphical images may include windows, fields, dialog boxes, menus, icons, buttons, cursors, scroll bars, etc. Such images may be arranged in predefined layouts, or may be created dynamically to serve the specific actions being taken by a user. During operation, the user can select and activate various graphical images in order to initiate functions and tasks associated therewith. By way of example, a user may select a button that opens, closes, minimizes, or maximizes a window, or an icon that launches a particular program. The GUI can additionally or alternatively display information, such as non interactive text and graphics, for the user on the display device 968.

The computer system 950 also includes an input device 970 that is operatively coupled to the processor 956. The input device 970 is configured to transfer data from the outside world into the computer system 950. The input device 970 may include a touch sensing device configured to receive input from a user's touch and to send this information to the processor 956. In many cases, the touch-sensing device recognizes touches, as well as the position and magnitude of touches on a touch sensitive surface. The touch sensing means reports the touches to the processor 956 and the processor 956 interprets the touches in accordance with its programming. For example, the processor 956 may initiate a task in accordance with a particular touch. A dedicated processor can be used to process touches locally and reduce demand for the main processor of the computer system. The touch sensing device may be based on sensing technologies including but not limited to capacitive sensing, resistive sensing, surface acoustic wave sensing, pressure sensing, optical sensing, and/or the like. Furthermore, the touch sensing means may be based on single point sensing or multipoint sensing. Single point sensing is capable of only distinguishing a single touch, while multipoint sensing is capable of distinguishing multiple touches that occur at the same time.

In the illustrated embodiment, the input device 970 is a touch screen that is positioned over or in front of the display 968. The touch screen 381 (also the input device 970) may be integrated with the display device 968 or it may be a separate component. The touch screen 381 has several advantages over other input technologies such as touchpads, mice, etc. For one, the touch screen 970 is positioned in front of the display 968 and therefore the user can manipulate the GUI directly. For example, the user can simply place their finger over an object to be selected, activated, controlled, etc. In touch pads, there is no one-to-one relationship such as this. With touchpads, the touchpad is placed away from the display typically in a different plane. For example, the display is typically located in a vertical plane and the touchpad is typically located in a horizontal plane. This makes its use less intuitive, and therefore more difficult when compared to touch screens.

The touchscreen 970 can be a single point or multipoint touchscreen. Multipoint input devices have advantages over conventional single point devices in that they can distinguish more than one object (finger) simultaneously. Single point devices are simply incapable of distinguishing multiple objects at the same time.

The computer system 950 also includes a proximity detection system 990 that is operatively coupled to the processor 956. The proximity detection system 990 is configured to detect when a finger (or stylus) is in close proximity to (but not in contact with) some component of the computer system including for example housing or I/O devices such as the display and touch screen. The proximity detection system 990 may be widely varied. For example, it may be based on sensing technologies including capacitive, electric field, inductive, hall effect, reed, eddy current, magneto resistive, optical shadow, optical visual light, optical IR, optical color recognition, ultrasonic, acoustic emission, radar, heat, sonar, conductive or resistive and the like. A few of these technologies will now be briefly described.

The computer system 950 also includes capabilities for coupling to one or more I/O devices 980. By way of example, the I/O devices 980 may correspond to keyboards, printers, scanners, cameras, speakers, and/or the like. The I/O devices 980 may be integrated with the computer system 950 or they may be separate components (e.g., peripheral devices). In some cases, the I/O devices 980 may be connected to the computer system 950 through wired connections (e.g., cables/ports). In other cases, the I/O devices 980 may be connected to the computer system 950 through wireless connections. By way of example, the data link may correspond to PS/2, USB, IR, RF, Bluetooth or the like.

In addition, the computer system 950 includes a GPS module 988 that communicates with the processor 956. The GPS 988 not only collects position information (latitude, longitude and elevation), but records this information at specific position points. For example, the position information is recorded when a user makes a position point recording request when investigating a particular property. The user may choose to record position points (sometimes referred to as property points) at the corners of the building on a parcel, or perhaps continuously records the position information as the user walks around the periphery of the building structure. Position information is then recorded in the memory 958, which may be stored locally if the application software is executed locally, or output through the I/O device 980 for processing at a remote site, such as through a dedicated server, or perhaps through a remote computer system such as in a cloud computing context.

### Calculation of Composite Hazard Index

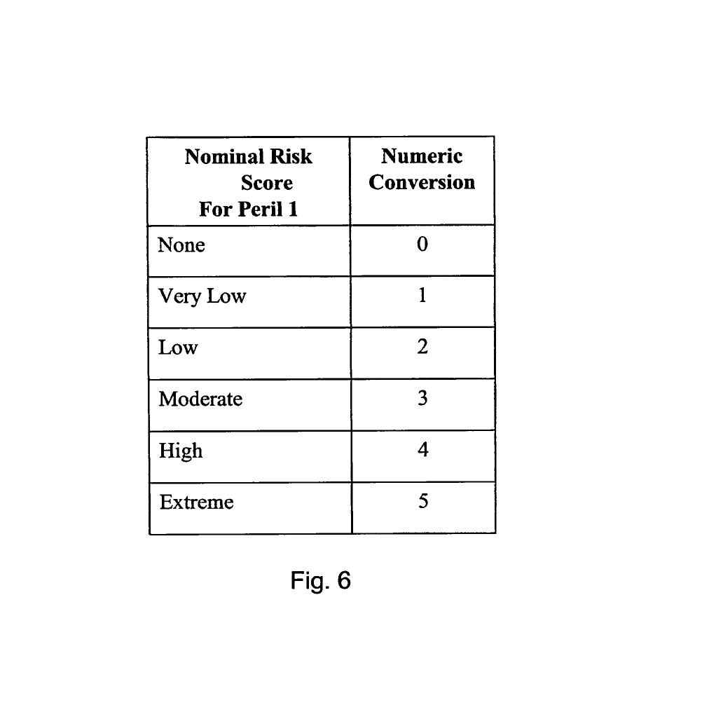

Risk for individual hazards is commonly measured by individual scores grounded on science, observations & data, and models of reality. The score for each hazard peril reflects the intensity and frequency of individual hazards. Because of various characteristics of those hazards and various scientific measurements used in hazard risk methodologies, those derived scores could be in different scales, ranges and formats. Therefore, a normalization of risk scores needs to be implemented. FIG. 6 includes a table that shows a conversion between a nominal risk score for a particular peril, peril 1, and a numeric equivalent. A particular peril, such as an earthquake, may be categorized using a text-based score. These non-numeric scores in the example of FIG. 6 range from “none” to “extreme”. The numeric conversion shown in FIG. 6 is an exemplary conversion from a nominal risk score to a numeric risk score. In this case the numeric conversion includes six different values, ranging from 0 to 5. While the figure describes peril 1 generically, it may be applied to any one of a variety of hazards, including flood, fire, earthquake, tornado, wind storm, hurricanes, storm surge, storm tide, lightning, thunder storm, hail, sinkholes, landslides, etc.

In theory, properties are our shelters and defense against natural hazard intrusions. Commonly, properties have some limited capability of keeping us protected from hazards (such as rains, winds, and other natural forces). In other words, properties have their tolerances against relatively low intensity natural hazards. However, when properties are located in high risk areas of natural hazards, properties could be severely damaged or destroyed by natural hazard events. In order to emphasize a particular hazard impact of the hazard peril with a higher risk, an emphasis on the numeric scores of the individual hazards may be used to emphasize or amplify the score weight to the hazards with more significant impact. This allows for a higher value to further promote high individual risk scores and penalize low risk. In the example shown before with regard to FIG. 6, one technique for amplifying the numeric score is to square (or to raise to an exponent) the score. While squaring is just one option, the present description is not limited to merely squaring, but also contemplates a wide variety of techniques for emphasizing high scores, and de-emphasizing low scores. This may be done with linear and non-linear application.

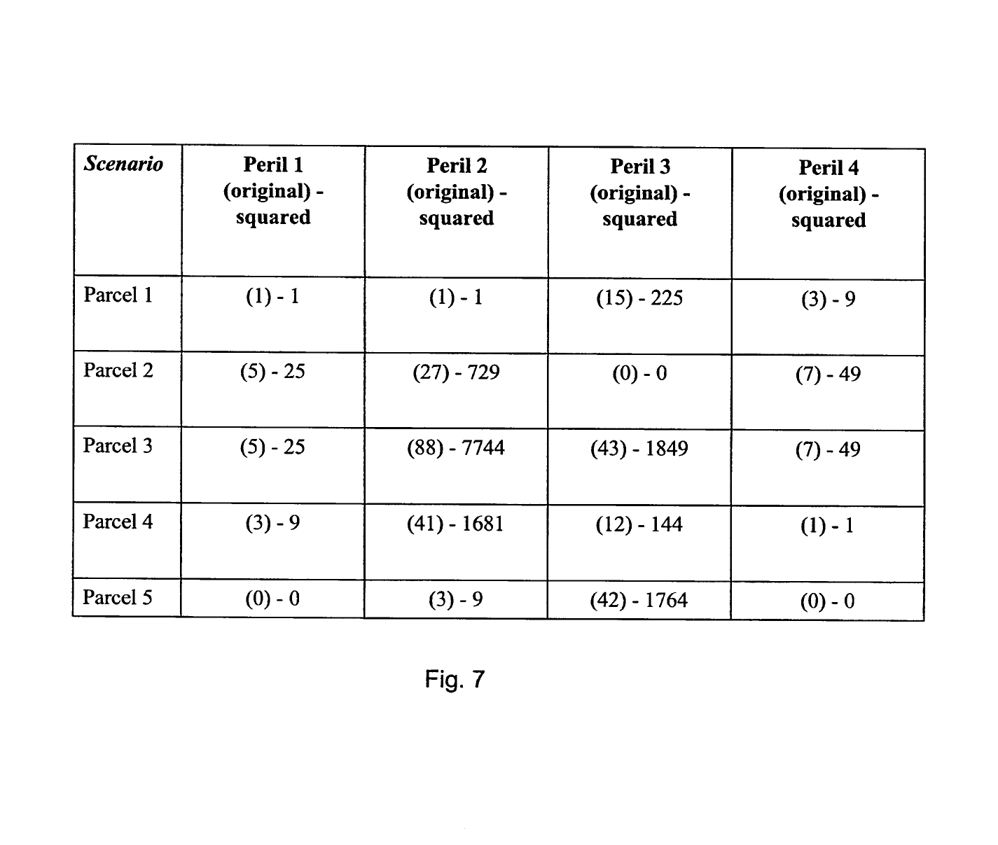

In reference to FIG. 7, emphasis is applied to scores towards the higher end of the range, by squaring their value. This has an opposite affect on values at the low end of the range, as they are de-emphasized relative to the high end scores by having values that once squared are at a much greater extreme relative to the top end of the score range. In the example of FIG. 7, a first parcel has its score for four different perils scored. In the example, the peril 1 has a score of 1, which when squared results in a squared score of 1. The score for peril 2 is similar. However, the score for peril 3 (15 in the example) when squared has a much higher value (225) when squared. Likewise peril 4 for parcel 1 has a score of 3, and when squared results in a score of 9. Each of these peril scores is based on the presumption that for peril 1 (nominal risk) is of one of the six categories shown in FIG. 6. Therefore, a score of 1 with regard to peril 1, is at the low end of the range (0 to 5). The numeric range for peril 2 ranges from 1 to 100, and therefore when scored ranges from 1 to 10,000. Likewise for peril 3 the numeric risk ranges from 1 to 50, which means when squared the range varies from 1 to 2,500. With regard to peril 4, the risk ranges from 1 to 10, and so the squared values range from 1 to 100.

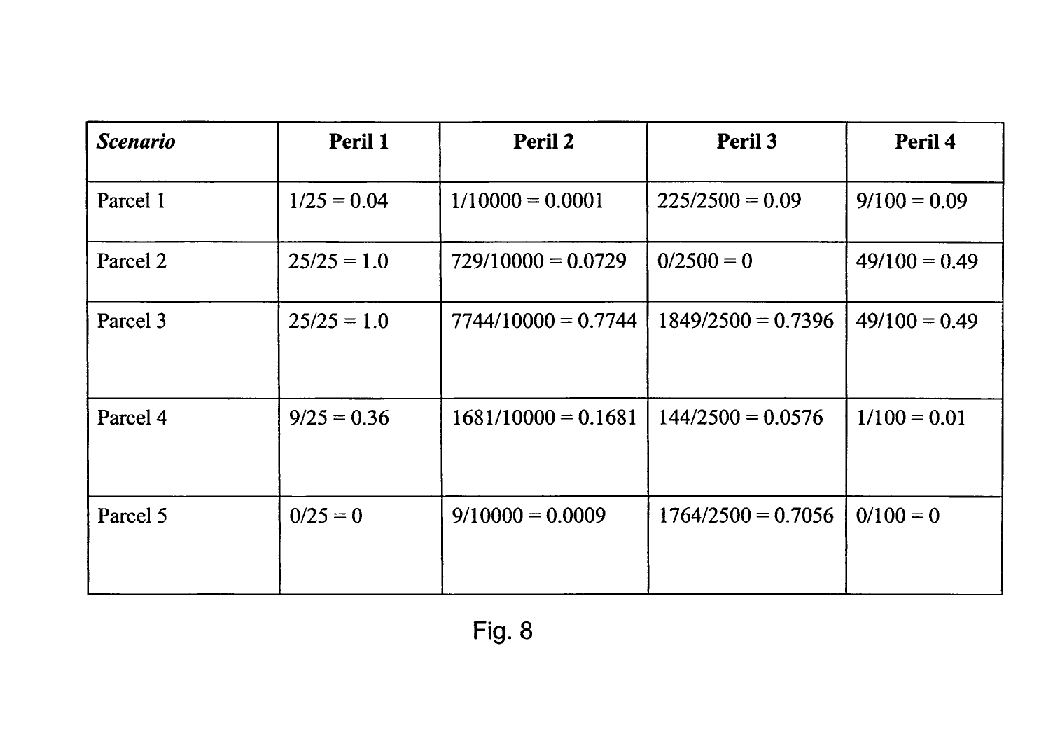

FIG. 8 is used to show for the example given, a normalization process, where the squared score is divided by the maximum score squared. FIG. 8 shows for each of five parcels in each of four perils, a normalized score under the scenario considered.

The total normalized score for each parcel may be then used to calculate the composite index of that total through a calculation process. In deriving a composite score, a number of different formulae may be used to provide that composite score, one option would be to use a “parameter approach”, which uses a logarithm formula (natural or base 10) as follows:

$$CompositeIndex = a * Log \{ {\sum }_{Peril = 1}^{n} \frac{{[ Score ( Peril ) ]}^{b}}{{\{ Max [ Score ( Peril ) ] \}}^{b}} \} + c$$

In this example, the multiplier “a” is a scaling factor that may be adjusted based on user setting, selected for the typical types of ranges experienced for a particular region or hazard mix. The value “b” (in the first example) is an exponential component, which in the example was set to integer 2, but could be a real value as well, depending on the spread of interest when normalizing the different scores. The value “c” is optional and is an offset that may be used to adjust (DC adjustment) depending on the particular scenario under consideration. The value c could be 0, or another real or integer value.

An alternative approach may be to use a polynomial formula like that shown below

$$CompositeIndex = a * {\{ {\sum }_{Peril = 1}^{n} \frac{{[ Score ( Peril ) ]}^{x}}{{\{ Max [ Score ( Peril ) ] \}}^{x}} \}}^{2} + b * \{ {\sum }_{Peril = 1}^{n} \frac{{[ Score ( Peril ) ]}^{x}}{{\{ Max [ Score ( Peril ) ] \}}^{x}} \} + c$$

Another approach would be to use a weighting formula such as that shown below.

Composite Index=(AAL₁/Total AAL)*Score₁+(AAL₂/Total AAL)*Score₂+ . . .

With regard to the weighting formula, the power value or weights from individual risk scores may also be determined by using average annual loss (AAL), which represents combination of hazard occurrence frequency and severity/loss, where AAL equals the sum of individual product of probability of hazard event occurrence and associated loss at the parcel. In this way, the AAL ratios may be used as a weight on the normalized risk scores from individual hazards when computing the total composite hazard index.

In a non-limiting example, in order to insure best fit to multiple normalized hazard scores, multiple extrapolation formulae may be used. In this case, if the total for any parcel is greater than 0.2, the upper equation may be used (with empirically set parameters, as shown in the first equation below), and when less than 0.2, in this example, the formula used to calculate the composite index is 6.2765*log(total score) plus 29.819 (as shown below).

$$CompositeIndex = 29.874 * Log \{ {\sum }_{Peril = 1}^{n} \frac{{[ Score ( Peril ) ]}^{2}}{{\{ Max [ Score ( Peril ) ] \}}^{2}} \} + 68.544$$

$$When the result of ( Σ ) >= 0.2 ; when CompositeIndex > 100 , set it = 100$$

$$CompositeIndex = 6.2765 * Log \{ {\sum }_{Peril = 1}^{n} \frac{{[ Score ( Peril ) ]}^{2}}{{\{ Max [ Score ( Peril ) ] \}}^{2}} \} + 29.819$$

$$When the result of ( Σ ) < 0.2 ( the low score tail section )$$

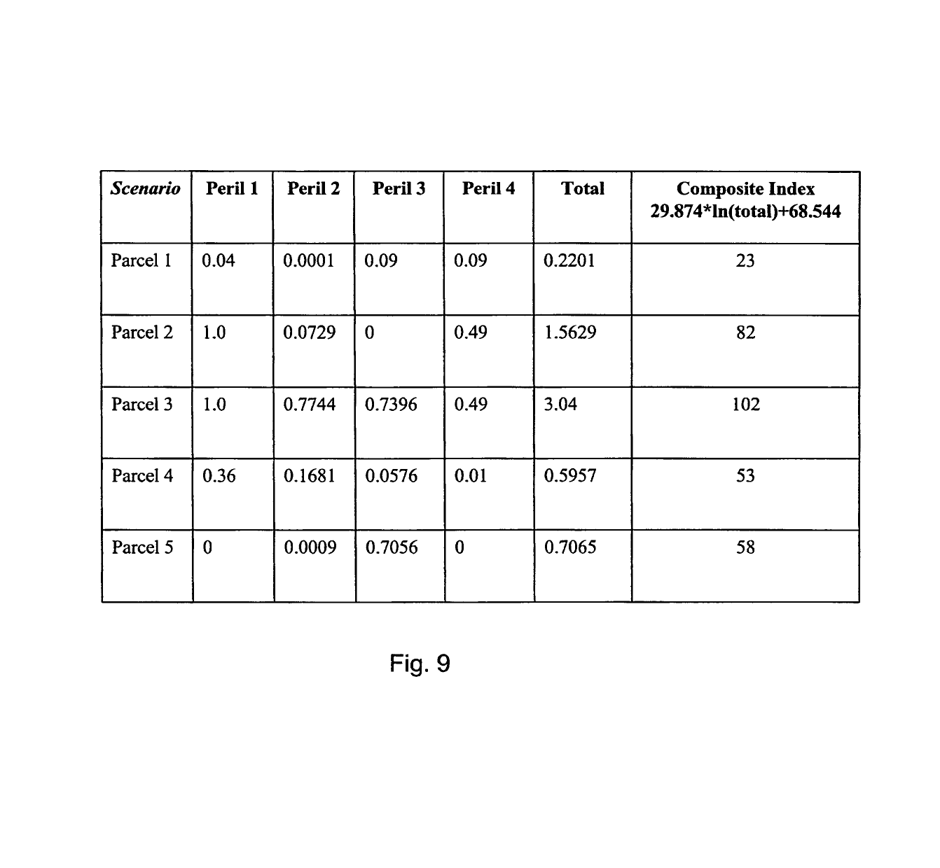

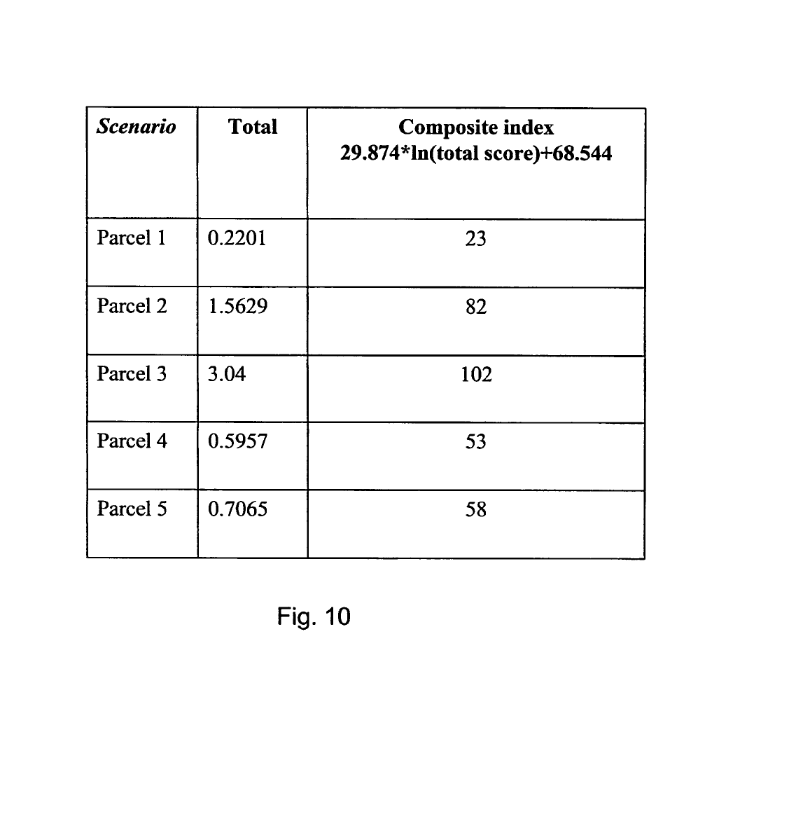

FIG. 9, shows the results of the composite index applied for parcels 1-5 for the four perils discussed previously with regard to FIGS. 7 and 8. As seen, for parcel 1, a parcel 1 composite index is shown as being 23, while the composite index for parcel 3 is 102.

FIG. 10 shows the association between the total normalized score for a particular parcel, saved in cooperation with the composite index. This information may be stored in a non-tangible computer-readable medium for retrieval and subsequent reporting to a service requiring information regarding the composite index for particular parcels. Because the parcels may be retrieved based on the parcel description (e.g., address) the composite index is usually retrievable and associated with a particular address so that insurance underwriters, etc. may quickly and conveniently provide an insurer with a tool to help them accurately evaluate and compare the risk for properties across an entire portfolio.

With regard to individual reasons, the individual risk scores in formulae used for computing the composite score may be calibrated and validated by actual loss data in a geographic area (such as zip code area, county and other). For example, a zip code area with higher occurrence of tornados and flooding should have a higher composite index than in areas that do not have the same level of risk from these particular hazards.

Because individual scores may be derived based on different physical sciences, sometimes, empirical curve fitting may also be used to create extrapolated values between the design range of the composite index. Therefore, the calculated composite score should be constrained within a predetermined range. For example if a composite index score is greater than 100, it should be capped at a value of 100. However, if the composite index score is less than 0.0 it may be assigned a value of 0. This would result in the final composite index score to range from 0 to 100. This computation of outliers, would be justifiable based on empirical curve fitting on actual experience. It may also assist in extrapolated values within the design range, based on a data set having greater statistical significance than when the outliers are excluded.

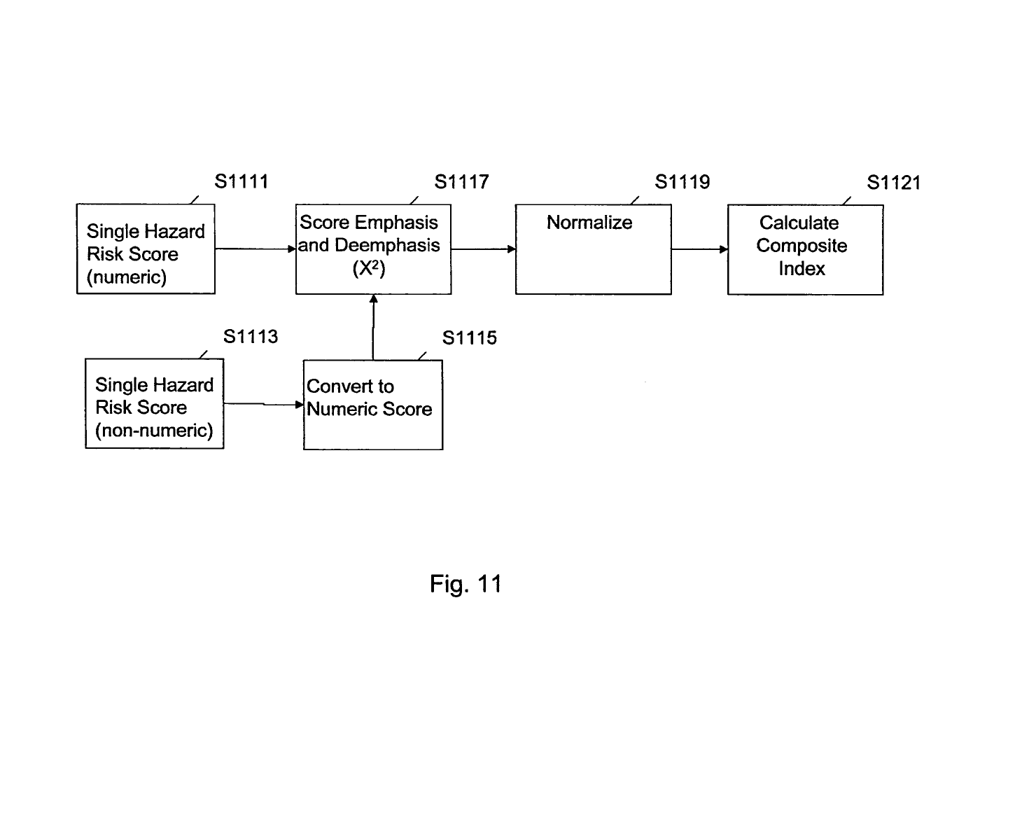

Different components of a methodology performed according to the present description have so far been provided. FIG. 11 provides a flow chart explaining different process steps that are employed between inputting different single hazard risk scores and resulting in a composite index. The process in FIG. 11 begins at step S1111 where a single hazard risk score having a numeric value is input into the analysis algorithm. Likewise, non-numeric hazard risk scores for hazards that are also subject to the analysis or input in step S1113. However, because the non-numeric risk scores are not in a numeric format, they are first converted to a numeric score in step S1115. The outputs of step S1111 and S1115 are input to step S1117, where the individual scores are emphasized at the high end and de-emphasized at the low end, where in this example, the scores are subject to a squaring process.

FIG. 7 provided a table of values that would result from the example previously discussed. The output of step S1117 is then input to step S1119, where the values for each of the different perils, for each parcel, are then normalized. FIG. 8 shows the results of the normalization process for particular parcels across a plurality of perils. Subsequently, in step S1121, a single composite index is calculated using a calculation process using one of the logarithmic, polynomial or weighted approach is, for example discussed above. Particular values in those optional calculations may be subject to adjustment and modification according to empirical data, curve fitting, or by directing the output to fall within predetermined ranges. Subsequently, the output of the composite index may be used to be delivered to users through a variety of media including Internet/web applications, via wireless communication and mobile devices, through APPS, data files, or the map layer for maps.

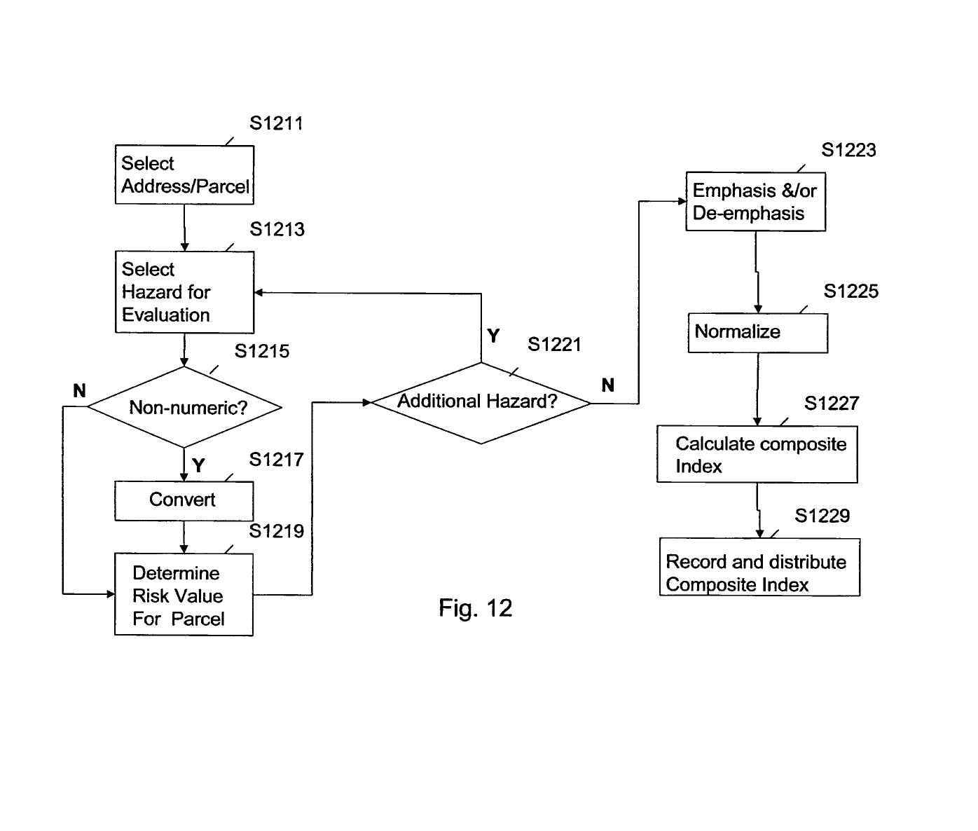

FIG. 12 is a flow chart of a process that may be performed either on a local device, or as a service to remote users, either by way of a server, or perhaps via a cloud computing resource. The process begins in step S1211, where a particular parcel is identified for analysis. It should be noted that the process in FIG. 12 may be performed for a first parcel, but then may be repeated for any one of a number of parcels in a user's portfolio. Moreover, a batch or a listing of different addressees, or even all addressees within a predetermined region may be automatically process through the process shown in FIG. 12 to result in composite scores for the parcels in the set of parcels subjected to analysis. In step S1211, the parcel may be identified either automatically through a rooftop/structure geocode, parcel geocode, street range geocode, or by another technique. The other techniques may be manually identified such as by address, GPS location from a mobile device, or a location defined via user input through a web map application or desktop application. In a non-limiting example a user may have a Smartphone or mobile tablet computer that when at a particular parcel may invoke the process requesting that the composite index value be determined for the parcel at which the Smartphone or tablet computer is presently located, as recognized by the GPS location from the mobile device.

Once the address is located the process proceeds to step S1213, where a first hazard, such as a brush fire, is selected to be evaluated. Then, if that particular hazard has non-numeric hazard categorizations (e.g., none, very low, low . . . ) then the querying step S1215, directs the process to step S1217, where the nominal classification is converted into numeric classification. If the results in query step S1215 is negative, the process also proceeds to step S1219, although by-passes the conversion step in S1217. The process then in step S1219 determines the risk value for that particular parcel.

This risk value associated with a particular address or parcel may use one of the following criteria for determining a risk value.

Risk value coincident with centroid of address parcel (point calculation)

Risk value comprising a majority of address parcel (area calculation)

Highest risk value coincident with address parcel regardless of risk area

Risk value coincident with centroid of built structure on address parcel (point calculation)

Risk value comprising a majority of built structure on address parcel (area calculation)

Highest risk value coincident with any part of built structure on address parcel

Averaged risk for entire parcel based on weighted percentage by area

Averaged risk for entire parcel based on non-weighted calculation

Averaged risk for structure based on weighted percentage by area

Averaged risk for structure based on non-weighted calculation

Highest risk located within a given distance of parcel boundary

Highest risk located within a given distance of structure on address parcel

After step S1219 the process proceeds to the query in step S1221 where it is determined whether there is an additional hazard to be evaluated. If so the process returns to step S1213 for additional processing as discussed above. However, if the response to the query in step S1221 is negative, the process proceeds to step S1223, where the scores are emphasized and/or de-emphasized, such as through a squaring operation as previously discussed. Then in step S1225 the emphasized/de-emphasized scores are normalized and then in step S1227 the composite index is calculated for the parcel. Subsequently in step S1229 the composite index is stored according to the particular parcel with which it is associated, and provided on an as-demand requested basis to remote users or processes that originated the query, or another predesignated destination. Subsequently the process ends.

Obviously, numerous modifications and variations of the present invention are possible in light of the above teachings. It is therefore to be understood that within the scope of the appended claims, the invention may be practiced otherwise than as specifically described herein.

1. An apparatus for determining a composite hazard index, comprising:
an interface that receives a first risk score for a first hazard and a second risk score for a second hazard, said first risk score being in a first range of scores and said second risk score being in a second range of scores; and
a processing circuit that
emphasizes at least some scores in at least one of said first range of scores and said second range of scores,
normalizes said first risk score with respect to the first range of scores and second range of scores,
normalizes said second risk score with respect to the first range of scores and second range of scores, and
combines a normalized first risk score with a normalized second risk score to form at least a component of a composite risk index, wherein
said first risk score and second risk score being specific to a common property.

2. The apparatus of claim 1, wherein
said processing circuit normalizes the first risk score and the second risk score after emphasizing scores in the first range of scores and the second range of scores.

3. The apparatus of claim 1, wherein
said processing circuit converts said second range of scores from non-numeric scores to numeric scores.

4. The apparatus of claim 1, wherein
said processing circuit emphasizes at least some scores at one end of said first range of scores and at one end of said second range of scores.

5. The apparatus of claim 1, wherein
said processing circuit emphasizes said at least some scores by applying an exponent to the at least some scores.

6. The apparatus of claim 5, wherein
said processing circuit squares said first risk score and at least a maximum risk score in said first range of scores.

7. The apparatus of claim 5, wherein
said processing circuit divides an emphasized first risk score by an emphasized maximum risk score of said first range of scores.

8. The apparatus of claim 1, wherein
said processing circuit combines the normalized first risk score with the normalized second risk score using at least one of a parameter formulation, an exponential formulation, a logarithmic formulation, a polynomial formulation, a power formulation and a weighting formulation.

9. The apparatus of claim 8, wherein
said weighting formulation contains weights derived from Average Annual Loss (AAL) from each individual hazard.

10. The apparatus of claim 1, wherein
said processing circuit sums said first normalized risk score with said second normalized risk score with other normalized risk scores for other hazards.

11. The apparatus of claim 1, wherein
said interface transmits said composite index to a remote computer.

12. The apparatus of claim 1, wherein
said interface receives a plurality of risk scores for a plurality of properties and determines composite risk scores for each of said plurality of properties.

13. The apparatus of claim 1, wherein:
said interface outputs a plurality of property points to a remote computer which determines said composite risk index for said common property.

14. The apparatus of claim 1, further comprising:
a composite risk score display that displays
a footprint of a building on said parcel, and
an indication of a present location.

15. The apparatus of claim 1, further comprising:
a positioning module that is a goeocoding system module based on property address information.

16. The apparatus of claim 15, wherein
said positioning module records property point information for each address and said property point information is used in determining said composite risk score for said geocodes that include latitude and longitude.

17. The apparatus of claim 1, wherein
the processing circuit includes a positioning module that is a global positioning system module hosted in at least one of a smartphone and a tablet-computer.

18. The apparatus of claim 17, wherein
said positioning module records property point information for each of a plurality of corners of a structure footprint, and said property point information is used in determining said composite risk index for said common property.

19. The apparatus of claim 18, wherein
said positioning module records property point information for any point within said structure footprint, and said property point information is used in determining said composite risk index for said common property.

20. A method for determining a composite hazard index, comprising:
receiving a first risk score for a first hazard and a second risk score for a second hazard via an interface, said first risk score being in a first range of scores and said second risk score being in a second range of scores; and
emphasizing with a processing circuit at least some scores in at least one of said first range of scores and said second range of scores,
normalizing said first risk score with respect to the first range of scores and second range of scores,
normalizing said second risk score with respect to the first range of scores and second range of scores, and
combining with said processing circuit a normalized first risk score with a normalized second risk score to form at least a component of a composite risk index, wherein
said first risk score and second risk score being specific to a common property.

21. The method of claim 20, wherein
said normalizing the first risk score is performed after the emphasizing.

22. The method of claim 20, further comprising
converting with said processing circuit said second range of scores from non-numeric scores to numeric scores.

23. The method of claim 20, wherein
said emphasizing emphasizes at least some scores at one end of said first range of scores and at one end of said second range of scores.

24. The method of claim 20, wherein
said emphasizing emphasizes said at least some scores by applying an exponent to the at least some scores.

25. The method of claim 24, wherein
said emphasizing includes squaring said first risk score and at least a maximum risk score in said first range of scores.

26. The method of claim 24, wherein
said normalizing said first risk score includes dividing an emphasized first risk score by an emphasized maximum risk score of said first range of scores.

27. The method of claim 20, wherein
said combining includes combining the normalized first risk score with the normalized second risk score using at least one of a parameter formulation, an exponential formulation, a logarithmic formulation, a polynomial formulation, a power formulation and a weighting formulation.

28. The method of claim 27, wherein
said weighting formulation contains weights derived from the Average Annual Loss (AAL) from each individual hazard.

29. The method of claim 20, wherein
said combining includes summing said first normalized risk score with said second normalized risk score with other normalized risk scores for other hazards.

30. The method of claim 20, further comprising
transmitting said composite index to a remote computer.

31. The method of claim 20, further comprising
receiving a plurality of risk scores for a plurality of properties, and
determining composite risk scores for each of said plurality of properties.

32. A non-transitory computer program storage device having instructions that when executed by a processing circuit perform a method for determining a composite hazard index, comprising:
receiving a first risk score for a first hazard and a second risk score for a second hazard via an interface, said first risk score being in a first range of scores and said second risk score being in a second range of scores; and
emphasizing with the processing circuit at least some scores in at least one of said first range of scores and said second range of scores,
normalizing said first risk score with respect to the first range of scores and second range of scores,
normalizing said second risk score with respect to the first range of scores and second range of scores, and
combining with said processing circuit a normalized first risk score with a normalized second risk score to form at least a component of a composite risk index, wherein
said first risk score and second risk score being specific to a common property.
